(19) United States
(12) Patent Application Publication
(10) Pub. No.: US 2002/0006481 A1
(43) Pub. Date: Jan. 17, 2002

(54) Color coated landscape stones, surface coating, preparations therefor, and methods of producing same

(76) Inventor: Barrington A. Morris, Coral Springs, FL (US)

Correspondence Address: MARK D. BOWEN, ESQ., STEARNS, WEAVER, MILLER, WEISSLER, ALHADEFF & SITTERSON PA., 200 EAST BROWARD BLVD., SUITE 1900, FT. LAUDERDALE, FL, 33301, US

(21) Appl. No.: 09/753,422

(22) Filed: Jan. 3, 2001

Related U.S. Application Data
(60) Provisional application No. 60/174,212, filed on Jan. 3, 2000.

(51) Int. Cl. B32B 9/00

(52) U.S. Cl. 428/15; 427/314; 427/393.6

(57) ABSTRACT

Vibrantly colored stones for use as decorative landscape elements are disclosed. The invention includes a process, including coating formulations, apparatus, and a method for preparing and applying specific acrylic-based color coatings to river rocks, stones, and the like thereby resulting in brightly colored decorative stones suitable for use in landscaping. End use stabilizers prevent color degradation, while the addition of faceted grains of mineral material enhance visual appearance. Colored stones produced according to the process herein are durable, colorfast, non-toxic, mildew resistant, algae resistant and otherwise environmentally safe. The stones may be used as decorative elements in a wide variety of landscape settings.

### CROSS REFERENCE TO RELATED APPLICATIONS

This application claims the benefit of provisional U.S. Patent Application Ser. No. 60/174,212, filed Jan. 3, 2000.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights.

### BACKGROUND OF THE INVENTION

1. Field of the Invention

The present invention relates to stones and rocks used primarily as landscaping and/or decorative display elements, and more particularly to vibrantly colored landscaping stones, color coating formulations for landscaping stones, and an apparatus and method for producing said stones.

2. Description of the Background Art

The use of river rock, and other stone material, as decorative landscaping and gardening elements is well known in the art. For example, river rock and stones are often used along walkways and driveways, around shrubbery and hedges, and in potted plants, in both indoor and outdoor environments. In such applications, the stones function as decorative elements by defining landscaped areas or otherwise contributing to the aesthetics of the environment. In addition, landscape stones are widely used to facilitate drainage and/or to form a durable surface, such as a walkway or roadway.

While river rock and stones are found in abundance in nature in a few basic natural colors, namely white, black, and shades of brown, there exists a need for more colorful stones for use in landscaping and the like. As used herein, the terms rock and stone may be considered synonyms and may be used interchangeably to generally describe any rock-like particles.

### BRIEF SUMMARY OF THE INVENTION

The present invention provides vibrantly colored stones for use as decorative landscape elements. The invention also includes a process, including an apparatus and method, for preparing specific color coating formulations and applying the coatings to river rocks, stones, and the like thereby resulting in brightly colored decorative stones suitable for use in landscaping. Colored stones produced according to the process herein are durable, colorfast (e.g. fade resistant), non-toxic, mildew resistant, algae resistant and environmentally safe. The stones may be used as decorative elements in a wide variety of indoor and outdoor environments for both decorative as well as functional applications.

The process generally includes: (1) obtaining and sorting stones into batches of certain dimensions, namely between ¾” and 3” in diameter (although both larger and smaller sizes may be best suited for certain applications); (2) preparing color coatings according to specific formulations which include organic and/or inorganic pigments and hindered amine light stabilizers that absorb and/or negate the color degradation effects of ultraviolet (“UV”) radiation thereby providing a greater degree of color longevity; (3) coating the stones with the previously prepared color coatings; (4) drying and curing the coated stones; (5) and, packaging the coated stones (optional as coated stones may be shipped in bulk).

Colored stones produced in accordance with the present invention are suitable for use in a wide variety of landscape applications. The instant invention thus provides vibrantly colored alternatives to conventional naturally “dull” colored river rock and stones. The selection of materials that form the coating, and process by which the various coatings are applied, result in a durable, colorfast, non-toxic, mildew resistant, algae resistant and otherwise environmentally safe landscaping product that significantly enhances the beauty of landscaped areas.

It is an object of the present invention to provide vibrantly colored rock and stone elements for use in landscaping and other suitable decorative uses.

Still another object of the present invention is to provide colorfast compositions which, when applied to various rocks and stones, result in colorful landscaping elements.

Yet another object of the present invention is to provide high-quality process by which color coatings may be quickly applied to river rock and stones in an efficient production process.

A further object of the present invention is to provide coating compositions that are colorful, colorfast, durable, non-toxic, mildew resistant, algae resistant and otherwise environmentally safe.

Still another object of the present invention is to provide colored coating compositions having compositions that prevent color degradation that would otherwise occur as a result of exposure to ultra-violet light.

### BRIEF DESCRIPTION OF THE SEVERAL VIEWS OF THE DRAWINGS

FIG. 1 is a perspective illustration showing a stone handling apparatus according to the present invention for heating and sorting stones;

FIG. 2 is a perspective illustration showing the stone coating apparatus for coating landscape stones;

FIG. 2A is a sectional view of rotating cylinder 70 shown in FIG. 2;

FIG. 3 is a perspective illustration showing the colored stone packaging apparatus;

FIG. 4 depicts a landscape stone coated in accordance with the present invention in partial sectional view;

FIG. 4A is an enlarged view of a portion of the landscape stone depicted in FIG. 4.

### DETAILED DESCRIPTION OF THE INVENTION

The following provides a detailed description of the surface coatings according to the present invention. The surface coatings disclosed herein, and the apparatus and method for applying same, provide vibrantly colored landscaping stones having decorative appeal. Colored stones produced according to the process herein are durable, colorfast, non-toxic, mildew resistant, algae resistant and otherwise environmentally safe. The coating compositions preferably include hindered amine light stabilizers that function to prevent color degradation from exposure, and specifically from exposure to ultra-violet radiation. The stones may be used as decorative elements in a wide variety of landscape settings.

### COLOR COATING FORMULATIONS

a. Clear Base Solution

The preparation of the color coatings for the stones includes several steps to achieve the desired coating having the desired properties. The initial step involves the production of a clear base solution from a mixture of liquid toluene (a liquid aromatic hydrocarbon C₇H₈ produced commercially from light oils) and an acrylic copolymer in the form of solid acrylic beads. In a preferred embodiment, the acrylic solids comprise approximately 24% by weight and the toluene comprises approximately 76% by weight, or, if by volume, a volumetric ratio of 2.62 (acrylic beads) to 10.53 (toluene). The clear base solution is mixed until the acrylic solids are completely dissolved whereafter the mixture is set aside to allow the dissipation of any accumulated air bubbles.

CLEAR BASE

| | % BY | % BY |
|---|---|---|
| SUBSTANCE | VOLUME | WEIGHT |
| Acrylic Beads | 02.62 | 24.00 |
| Toluene | 10.53 | 76.00 |

b. Intermediate Pigment Formulations

The color coating formulation further includes the preparation of pigment containing intermediates. In the preferred embodiment, intermediate formulations are produced from a combination of substances including the clear base solution, various inorganic pigments and toluene. For example, an intermediate referenced as frost paste blue (vibrant blue color) is prepared by combining clear base, pthalocyanine blue (Formula: C₃₂H₁₆N₈Cu) and toluene in the following respective proportions by weight (6.0:10.0:28.88), or equivalently by volume (0.79:0.75:4.00), and mixing to a 7 Hegman grind (minimum).

FROST PASTE BLUE INTERMEDIATE

| | % BY | % BY |
|---|---|---|
| SUBSTANCE | VOLUME | WEIGHT |
| Clear Base | 00.79 | 06.00 |
| Phthalo Blue | 00.75 | 10.00 |
| Toluene | 04.00 | 28.88 |

The intermediate formulation referenced as frost paste red (vibrant red color) is prepared by combining clear base, an inorganic cadmium pigment (chemical formula: CdS/CdSe·BaSO₄) and toluene in the following respective proportions by weight (6.0:10.0:28.88), or equivalently by volume (0.79:0.63:4.00), and mixing to a 7 Hegman grind (minimum).

FROST PASTE RED INTERMEDIATE

| | % BY | % BY |
|---|---|---|
| SUBSTANCE | VOLUME | WEIGHT |
| Clear Base | 00.79 | 06.00 |
| Cd Pigment Red | 00.63 | 10.00 |
| Toluene | 04.00 | 28.88 |

The intermediate formulation referenced as frost paste green (vibrant green color) is prepared by combining clear base, a green copper complex pigment (C₃₂H₂N₈CuCl₁₄), and toluene in the following respective proportions by weight (6.0:10.0:28.00), or equivalently by volume (0.79:0.52:4.00) and mixing to a 7 Hegman grind (minimum).

FROST PASTE GREEN INTERMEDIATE

| | % BY | % BY |
|---|---|---|
| SUBSTANCE | VOLUME | WEIGHT |
| Clear Base | 00.79 | 06.00 |
| Phthalo Green | 00.52 | 10.00 |
| Toluene | 04.00 | 28.88 |

As should be apparent, further intermediate formulations corresponding to other colors (e.g. yellow—using inorganic pigment CdS/ZnS·BaSo₄) may be prepared in accordance with the present invention. The above referenced intermediate formulations comprise colorful pigment compositions that been specifically selected based on extensive research and testing for use in connection with the specific size of stones disclosed herein (i.e. ¾” to 3”) and has been found to give optimum results for stones of this size.

c. Final Coatings

After preparation of the intermediate formulations, final coatings are produced as follows. A vibrant blue stone coating, is prepared by first pre-mixing acrylic beads and toluene in the following respective proportions by weight 24.0:162.45, or equivalently by volume (2.62:22.50), in a clean vat until a clear solution is formed. Then, while mixing at low speed, the following are added to the mixture: a Mica/Titanium Dioxide inorganic pigment available under the trademark AFFLAIR® 119 Polar White (AFFLAIR is a registered trademark of E.I. Du Pont de Nemours and Company) (chemical formula—K₂Al₆Si₆O₂₀(OH)₄, TiO₂), frost paste blue intermediate solution (as described above), Tinuvin 292, and Tinuvin 1130 in the following respective proportions by weight 9.0:2.0:4.49:4.49, or equivalently in the following respective proportions by volume 0.36:0.25:0.54:0.46.

FINAL COATING BLUE

| | | |
|---|---|---|
| | % BY | % BY |
| SUBSTANCE | VOLUME | WEIGHT |

Step 1

| | | |
|---|---|---|
| Acrylic Beads | 02.62 | 024.00 |
| Toluene | 22.50 | 162.45 |

Step 2

| | | |
|---|---|---|
| Afflair 119 | 00.79 | 006.00 |
| Frost Paste Blue | 00.25 | 002.00 |
| Tinuvin 292 | 00.54 | 004.49 |
| Tinuvin 1130 | 00.46 | 004.49 |

A red stone coating is produced in a similar manner, namely, by first premixing acrylic beads and toluene in the following respective proportions by weight 24.0:162.45, or equivalently by volume (2.62:22.50), in a clean vat until a clear solution is formed. Then, while mixing at low speed, the following are added to the mixture: a Mica/Titanium Dioxide inorganic pigment (AFFLAIR® 119), frost paste red intermediate (as described above), Tinuvin 292, and Tinuvin 1130 in the following respective proportions by weight 9.0:2.0:4.49:4.49, or equivalently in the following respective proportions by volume 0.36:0.25:0.54:0.46.

FINAL COATING RED

| | | |
|---|---|---|
| | % BY | % BY |
| SUBSTANCE | VOLUME | WEIGHT |

Step 1

| | | |
|---|---|---|
| Acrylic Beads | 02.62 | 024.00 |
| Toluene | 22.50 | 162.45 |

Step 2

| | | |
|---|---|---|
| Afflair 119 | 00.36 | 009.00 |
| Frost Paste Red | 00.24 | 002.00 |
| Tinuvin 292 | 00.54 | 004.49 |
| Tinuvin 1130 | 00.46 | 004.49 |

A green stone coating is produced in a similar manner, namely, by first premixing acrylic beads and toluene in the following respective proportions by weight 24.0:162.45, or equivalently by volume (2.62:22.50), in a clean vat until a clear solution is formed. Then, while mixing at low speed, the following are added to the mixture: a Mica/Titanium Dioxide inorganic pigment (AFFLAIR® 119), frost paste green intermediate (as described above), Tinuvin 292, and Tinuvin 1130 in the following respective proportions by weight 9.0:2.0:4.49:4.49, or equivalently in the following respective proportions by volume 0.36:0.24:0.54:0.46.

FINAL COATING GREEN

| | | |
|---|---|---|
| | % BY | % BY |
| SUBSTANCE | VOLUME | WEIGHT |

Step 1

| | | |
|---|---|---|
| Acrylic Beads | 02.62 | 024.00 |
| Toluene | 22.50 | 162.45 |

Step 2

| | | |
|---|---|---|
| Afflair 119 | 00.36 | 009.00 |
| Frost Paste Blue | 00.24 | 002.00 |
| Tinuvin 292 | 00.54 | 004.49 |
| Tinuvin 1130 | 00.46 | 004.49 |

A violet stone coating is produced in a similar manner, namely, by first premixing acrylic beads and toluene in the following respective proportions by weight 24.0:162.45, or equivalently by volume (2.62:22.50), in a clean vat until a clear solution is formed. Then, while mixing at low speed, the following are added to the mixture: a Mica/Titanium Dioxide inorganic pigment (AFFLAIR® 119), frost paste blue intermediate (as described above), frost paste red intermediate (as described above), Tinuvin 292, and Tinuvin 1130 in the following respective proportions by weight 9.0:1.0:1.0:4.49:4.49, or equivalently in the following respective proportions by volume 0.36:0.12:0.12:0.54:0.46.

FINAL COATING VIOLET

| | | |
|---|---|---|
| | % BY | % BY |
| MATERIAL | VOLUME | WEIGHT |

Step 1

| | | |
|---|---|---|
| Acrylic Beads | 02.62 | 024.00 |
| Toluene | 22.50 | 162.45 |

Step 2

| | | |
|---|---|---|
| Afflair 119 | 00.36 | 009.00 |
| Frost Paste Blue | 00.12 | 001.00 |
| Frost Paste Red | 00.12 | 001.00 |
| Tinuvin 292 | 00.54 | 004.49 |
| Tinuvin 1130 | 00.46 | 004.49 |

As should be apparent, stone coatings of various colors may be produced by adjusting the respective pigment proportions and primary color combinations. Accordingly, the present invention contemplates the preparation of various other colors. In addition, organic pigments may be used in lieu of or in combination with inorganic pigments specifically disclosed herein.

d. Characteristics Of The Final Coatings

The use of the Mica/Titanium Dioxide inorganic pigment (AFFLAIR® 119 Polar White) is optional, but is considered desirable due to the “sparkle” quality or effect that stones coated with the Mica/Titanium Dioxide appear to have as a result of the faceted shape of the minerals therein and the resulting visual effects from light reflected therefrom. The sparkle quality is particularly desirable as the stones prepared according to the present invention are primarily used outdoors where reflected sun light and/or outdoor lighting enhances the effect.

The coatings also include end use stabilizers such as Tinuvin 292 and Tinuvin 1130 to prevent color degradation. These end use stabilizers are particularly effective in the ultraviolet spectrum. Tinuvin 1130 is a hindered amine light stablizer and has been found to prevent color degradation by stabilizing the color coating and preventing the pigment particles from separating from the resin during prolonged periods of exposure to sunlight. Tinuvin 292 also prevents color degradation and functions as an ultraviolet absorbing agent.

Stones coated with the coating formulations disclosed herein are provided with a uniform acrylic layer that covers the natural pores existing in the stones. The acrylic coating prevents moisture from penetrating and/or accumulating in the pores or mineral structure. By preventing moisture penetration into the pore cavities, the coated stones are largely resistant to the growth of mildew and algae. This characteristic is further enhanced since the stones are heated prior to application of the coating thereby causing the evaporation of any moisture that may be in the stones. Accordingly, the stones retain a desirable mildew-free and algae-free appearance thereby extending the useful life of the stones as decorative landscape elements.

Apparatus and Method for Applying Surface Coatings

With reference now to the drawings there is depicted apparatus useful in producing colored landscaping stones in accordance with the present invention.

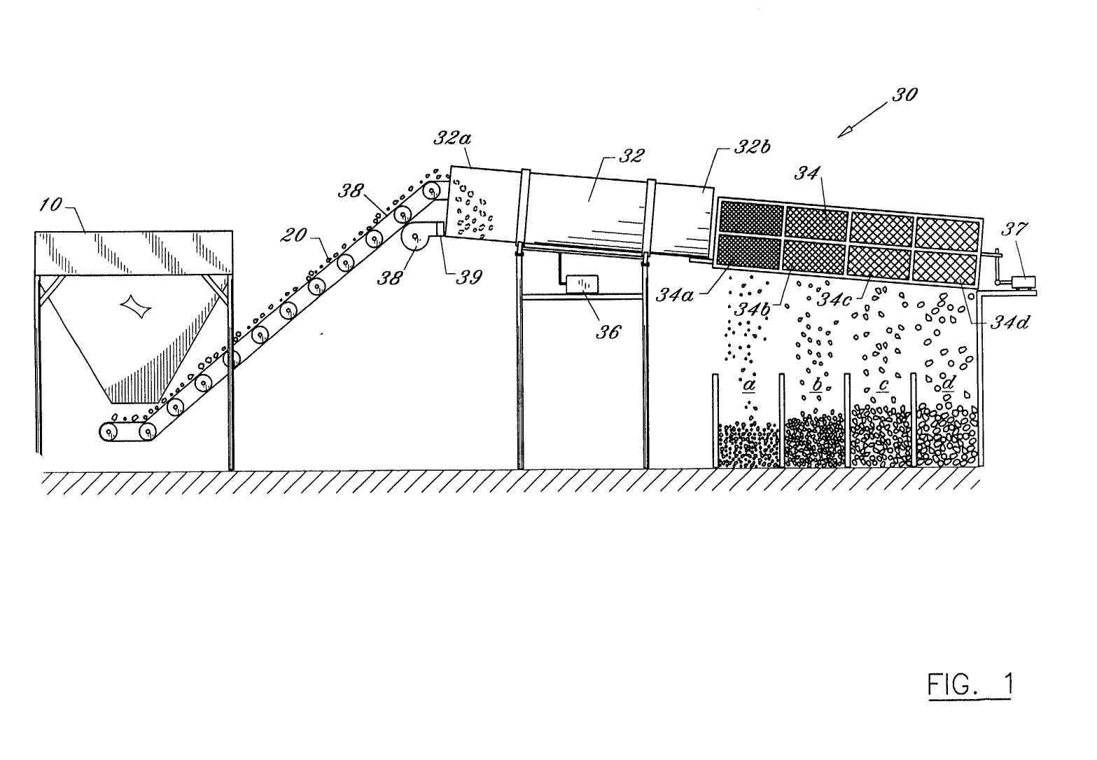

The color coating process of the present invention has been optimized for use with river rock and stones ranging in diameter from approximately ¾” to 3” in diameter. It should be noted, however, that the methods disclosed herein may be adapted for use with larger and/or smaller size stones. As depicted in FIG. 1, the invention provides for sorting the appropriate sized stones from bulk quantities of mined river rock, typically obtained from a suitable mine or quarry. In a preferred embodiment, sorting is accomplished by loading a bulk quantity of stones into an apparatus that includes a hopper-type receptacle 10. The stones are discharged from the hopper through the hopper outlet to a conveyer 20. The conveyer carries the stones upward to the opening (elevated end) of an inclined rotating sorter assembly, generally referenced as 30, including a rotating cylindrical tumbler 32 and a rotating mesh sorter 34. The rotating cylindrical tumbler 32, and rotating sorter 34 are each preferably power driven, such as by electric motors referenced as 36 and 37 respectively. The stones enter a first end 32a of rotating inclined cylindrical tumbler 32 wherein the stones are tumbled toward a second end 32b. The stones are preferably heated by any suitable heating means. In a preferred embodiment, a forced air furnace, including a fan 38 and heating element 39, is located at or near the first end 32a of the rotating tumbler 32 such that hot air is forced into tumbler 32 for the purpose of heating the stones during the tumbling/sorting process. Heating the stones is significant as it functions to remove moisture. Once heated and sorted according to the desired size parameters (e.g. approximately ¾” to 3”), the stones are ready for the application of the above-referenced color coatings. The stones exit the tumbler 32 and are discharged into a rotating sorter 34 having a series of mesh sections with various sized mesh openings 34a to 34d. The rotating mesh sorter 34 functions to allow stones, corresponding to the size of the mesh openings, referenced as 34a through 34d, to pass through the mesh into stone retaining receptacles thereby providing bulk quantities of sorted stones of pre-selected sizes.

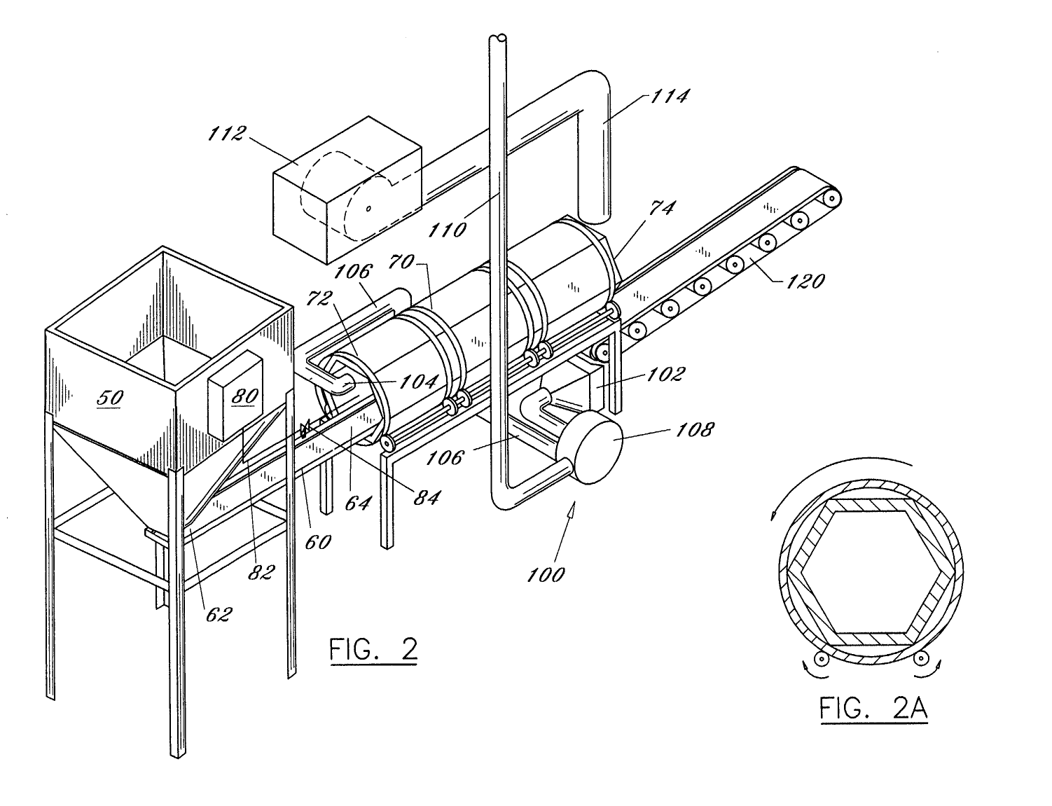

As depicted in FIG. 2, application of the previously prepared final color coating formulations to the previously sorted stones is achieved using a hopper-type device 50, having inwardly and downwardly sloping walls terminating at an outlet for discharging stones. A vibratory conveyer 60 is positioned so as to have a first end 62 located directly under the outlet of hopper 50, and a second end 64 terminating at the opening of a hexagonally shaped rotating cylinder 70 having an entering end 72 and a leaving end 74. A previously prepared final coating formulation is poured into an elevated container 80 having a dispensing conduit 82 terminating within the cylinder proximate end 72 to allow for the coating to flow directly into the cylinder entering end 72 and conveyer end 64. A manually actuated flow control valve 84 is incrementally positionable from a closed position, wherein coating flow is prevented, to an open position wherein liquid coating flows into cylinder 70. An electric motor is mechanically connected to cylinder 70 to cause rotation of the cylinder thereby causing the stones and coating material contained therein to mix such that the stones become fully and uniformly coated.

An exhaust system 100 provides for ventilation and removal of noxious fumes generated by the various chemicals present in the color coatings. Exhaust system 100 includes two air intake devices, referenced as 102 and 104, connected by suitable exhaust ductwork 106 to the inlet of a centrifugal exhaust fan 108. The exhaust fan outlet is connected to a vertically extending exhaust duct 110 that terminates at an outlet well elevated above the work area for discharging fumes into the atmosphere and away from personnel on the ground. The exhaust system further includes a centrifugal ventilation fan 112 which has an outlet connected to a ventilation duct 114 terminating near the leaving end of cylinder 70. Ventilation duct 114 functions to direct air across the outlet of cylinder 70 and toward exhaust intake device 102 to maximize the capture of noxious fumes while the moving air simultaneously functions to cure the color coating by cooling the previously heated stones.

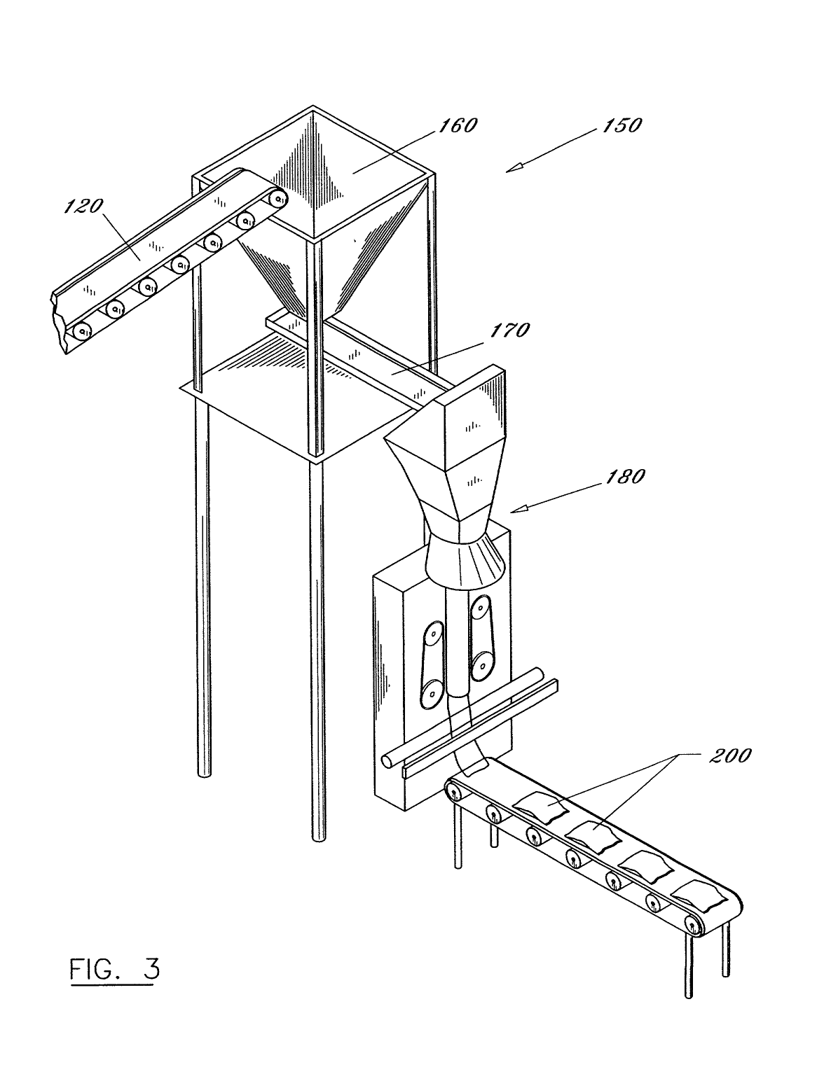

Coated stones exit cylinder 70 and are allowed to cure. Once cured, the coated stones are transported on conveyer 120 to packaging machinery, referenced as 150, as seen in FIG. 3. The packaging machinery includes a hopper device 160 having an outlet for discharging coated stones on to a conveyer 170. Conveyer 170 transports coated stones from hopper 160 to packaging machinery 180 wherein stones are deposited in suitable packaging material 200 and sealed.

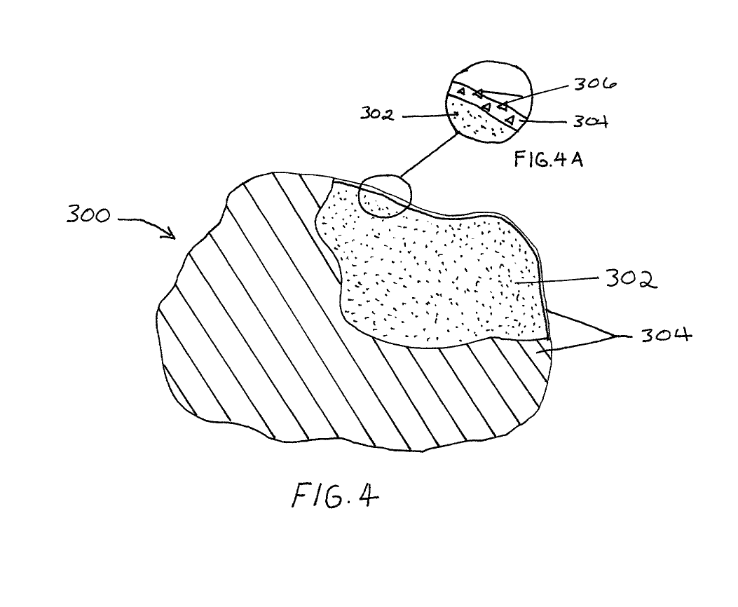

FIG. 4 depicts a stone, referenced as 300, coated in accordance with the process disclosed herein, in partial sectional view. Coated stone 300 is depicted as representative of the many types and shapes of objects that may be coated and used as decorative landscape elements in accordance with the present invention. Stone 300 includes a body 302 and an external coating 304. External coating 304 may include faceted mineral material 306 as best seen in FIG. 4A. The external coating depicted in FIG. 4 is shaded for the color green representing the frost paste green coating formulation disclosed hereinabove, however, it should be apparent that any suitable color falls within the scope of the invention.

The decorative landscaping elements disclosed herein are preferably packaged in plastic bag type containers capable of handling 25 lbs. of colored rock. Each 25 lb. bag contains enough colored rock to cover between 2-4 square feet of landscape area to a depth of approximately 1”.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What I claim is:

1. A decorative landscaping element comprising:
a rock-like structure having an external coating, said coating comprising at least one predetermined color.

2. A decorative landscaping element according to claim 1, wherein said rock-like structure is nominally sized between ¾” and 3”.

3. A decorative landscaping element according to claim 1, wherein said external coating includes an organic pigment.

4. A decorative landscaping element according to claim 1, wherein said external coating includes an inorganic pigment.

5. A decorative landscaping element according to claim 1, wherein said external coating includes a copper complex pigment.

6. A decorative landscaping element according to claim 1, wherein said external coating includes hindered amine light stabilizers.

7. A decorative landscaping element according to claim 1, wherein said external coating includes faceted mineral particles.

8. A decorative landscaping element according to claim 7, wherein said faceted mineral includes mica.

9. Decorative landscaping elements for use in garden and landscaped areas, said landscaping elements comprising:
river rock, said river rock having a size larger than ¾”;
said river rock having an external coating applied thereto, said external coating including a pigment corresponding to at least one predetermined color;
said external coating including at least one end use stabilizer.

10. Decorative landscaping elements according to claim 9, wherein said end use stabilizer is a hindered amine light stabilizer.

11. Decorative landscaping elements according to claim 9, wherein said hindered amine light stabilizer is Tinuvin.

12. An external surface coating composition for use on rocks and stones used as decorative landscaping elements, said coating composition including toluene, an acrylic copolymer, an inorganic pigment.

13. An external surface coating composition according to claim 12, further including mica.

14. An external surface coating composition according to claim 12, further including titanium dioxide.

15. An external surface coating composition according to claim 12, further including an end use stabilizer.

16. An external surface coating composition according to claim 15, wherein said end use stabilizer is Tinuvin.

17. An external surface coating composition for use on the external surfaces of rocks and stones used as decorative landscaping elements, said coating composition including toluene, an acrylic copolymer, an inorganic pigment, mica, titanium dioxide, and an end use stabilizer.

18. An external surface coating composition according to claim 17, wherein said end use stabilizer is a hindered amine light stabilizer.

19. A method of producing colored stones for use as decorative landscaping elements, said method including the steps of:
(a) sorting stones into batches sized between approximately ¾ and 3”;
(b) preparing an external surface coating composition, said composition including toluene, an acrylic copolymer, and an inorganic pigment;
(c) heating said stones;
(d) applying said coating composition to said heated stones and allowing the coated stones to cure.

20. A method of producing colored stones for use as decorative landscaping elements according to claim 20, wherein said external surface coating composition includes light stabilizers for preventing color degragdation.
